(19) United States
(12) Patent Application Publication
(10) Pub. No.: US 2007/0087100 A1
(43) Pub. Date: Apr. 19, 2007

(54) Apparatus and method for making multiple component confectionery product

(76) Inventor: Joan Fabre Fornaguera, Sant Cugat del Valles (ES)

Correspondence Address: BELL, BOYD & LLOYD LLP, P.O. Box 1135, CHICAGO, IL, 60690, US

(21) Appl. No.: 11/539,419

(22) Filed: Oct. 6, 2006

Related U.S. Application Data
(60) Provisional application No. 60/724,645, filed on Oct. 7, 2005.

(51) Int. Cl. A23L 1/00

(52) U.S. Cl. 426/516

(57) ABSTRACT

An apparatus and method are provided for producing a multiple component confectionery product. The apparatus includes an outer passageway concentrically disposed about an inner passageway, the passageways having a common exit port. The outer passageway has an outer diameter, the apparatus further including an outlet member surrounding the outer passageway, the outlet member being moveable about the outer passageway to vary the outer diameter. The apparatus may be used to produce a coextruded multiple component confectionery article having an inner confectionery material surrounded by an outer confectionery material. The confectionery article may have a substantially uniform diameter along the entire length thereof

### PRIORITY CLAIM

This patent application claims the benefit of U.S. Provisional Application No. 60/724,645, filed on Oct. 7, 2005.

### BACKGROUND

The present disclosure relates to an apparatus and method for producing a multiple component confectionery product. More particularly, the present invention relates to a confectionery coextrusion apparatus for depositing a consistent or uniform amount of each coextrudate.

The coextrusion of confectionery materials is a known production method for making a plethora of confectionery articles from hard candies to chewing gum. Typical extruders include one or more screws to deliver one or more fluid confectionery materials through respective barrels and discharged from a dispensing outlet to form confectionery articles as desired. The flow rate of each coextrudate is typically dictated by the rotation rate of the screw, the screw typically located upstream from the actual dispensing site. As a result, conventional confectionery extrusion systems experience significant lag time between detection of a coextrudate flow rate problem at the dispensing outlet and adjustment of the screw rotation rate to correct the flow problem. To complicate matters, many confectionery materials, chewing gum in particular, do not exhibit predictable fluid properties when placed in a flowable state. This further limits the ability to control uniform dispensing of confectionery material with conventional screw-drive extrusion devices. A need therefore exists for a coextrusion apparatus and method that can accommodate the unpredictable flow and elastic properties demonstrated by fluid confectionery materials. In particular, a need exists for a confectionery extrusion device capable of precisely controlling extrudate flow rate at the dispensing point.

### SUMMARY

The present disclosure provides an apparatus for producing a multiple component confectionery product or article. The apparatus includes an outer passageway that is concentrically disposed about or otherwise surrounds an inner passageway. The outer and inner passageways share a common exit port. The outer passageway has a an outer diameter. An outlet member surrounds the outer passageway, the outlet member being moveable about the outer passageway. Movement of the outlet member along the outer passageway varies the outer diameter.

The outer passageway is adapted to receive a first fluid confectionery material and the inner passageway is adapted to receive a second fluid confectionery material. The outlet member may be adjusted as desired to form a multiple component confectionery extrudate upon coextrusion of the first and second fluid confectionery materials from the common exit port. In an embodiment, the outlet member is adjusted to form a multiple component extrudate that has a uniform diameter along substantially the entire length of the extrudate.

In an embodiment, the apparatus further includes a sensor device, either in conjunction with or proximate to, the common exit port. The senor device is adapted to detect a property of the extrudate. The senor device is in operative communication with the outlet member and the outlet member may be moved in response to the property detected by the sensor device. In an embodiment, the sensor device sends a detection signal to a controller in operative communication with the sensor device and the outlet member. The controller is configured to move or otherwise direct movement of the outlet member in response to the detection signal.

In an embodiment, the sensor device may be a light emitter/receiver for detecting the diameter of the extrudate. The sensor device may include a flow rate detector capable of detecting the flow rate of the extrudate as well as the outer and/or inner fluid confectionery materials. The sensor device may also be a weighing device for weighing a segment of the extrudate. The sensor device may include any combinations of the above devices. Accordingly, the properties that the sensor device may detect include the extrudate diameter, the weight of the extrudate, the flow rate of the extrudate, the flow rate of the outer fluid confectionery material, the flow rate of the inner fluid confectionery material and any combination thereof.

In an embodiment, the outlet member moves with respect to the passageways to increase the length or distance of the outer diameter when the detection signal includes a detected value that is below a predetermined value. Similarly, the outlet member may be moved to decrease the length of the outer diameter when the detection signal includes a detected value that is greater than, or optionally greater than or equal to a predetermined value.

In a further embodiment, the controller is operatively connected to a drive mechanism that drives the movement of the outlet member. The controller may be configured to direct the drive mechanism to move the outlet member in response to the detection signal and/or the detected value sent by the sensor device. In an embodiment, the controller determines how much the outlet member is to be moved based on a comparison of the detected value and the predetermined value in order to ensure the extrusion of an extrudate having a uniform diameter along substantially the entire length thereof.

In an embodiment, the apparatus produces a multiple component confectionery article having an inner confectionery material and an outer confectionery material. The outer confectionery material surrounds the inner confectionery material and the confectionery article has a uniform diameter along substantially the entire length thereof The inner and outer confectionery materials may be any confectionery material as is commonly known in the art. In an embodiment, the inner confectionery may be a liquid, a solid, a semi-solid, powdered candy, granular candy, or combinations thereof In an embodiment, the outer confectionery material is chewing gum. The multiple component confectionery article may be a rope that may be shaped or formed into filled confectioneries or filled gumballs as desired.

A method for producing a multiple component confectionery article is provided in a further embodiment. The method includes coextruding an outer fluid confectionery and an inner fluid confectionery from respective outer and inner concentric passageways, the passageways having a common exit port. The outer passageway has an outer diameter and an outlet member surrounds the outer passageway. The method includes moving the outlet member about the outer passageway to vary the outlet diameter. In an embodiment, the method entails surrounding the inner fluid confectionery with the outer fluid confectionery to form a multiple component extrudate, detecting a property of the extrudate and adjusting the movement of the outlet member responsive to the detected property. The method thereby varies the length or distance of the outer diameter in response to the detected property.

In an embodiment, the outlet member movement is adjusted to form an extrudate having a substantially uniform diameter along substantially the entire extrudate length. The detecting may be performed by a sensor device. The adjusting may include moving the outlet member to increase the outlet diameter when the detected property is below a predetermined value. Similarly, the adjusting may also include moving the outlet member to decrease the outlet diameter when the detected property is greater than a predetermined value.

Additional features and advantages are described herein, and will be apparent from, the following Detailed Description and the Figures.

### BRIEF DESCRIPTION OF THE FIGURES

FIG. 1 is a partially broken-away perspective view of a confectionery depositing apparatus in accordance with the present disclosure.

FIG. 2 is an enlarged, partially broken-away perspective view of the confectionery depositing apparatus of FIG. 1.

FIG. 3 is sectional view of the confectionery depositing apparatus of taken along line 3-3 of FIG. 1.

FIG. 4 is an enlarged fragmentary view of Area 4 of FIG. 3 showing an outer passageway with a shortened outer diameter length in accordance with an embodiment of the present disclosure.

FIG. 5 shows the outer passageway of FIG. 4 having an increased outer diameter length in accordance with an embodiment of the present disclosure.

FIG. 6 is a sectional view taken along line 6-6 of FIG. 4.

FIG. 7 is a sectional view taken along line 7-7 of FIG. 5.

### DETAILED DESCRIPTION

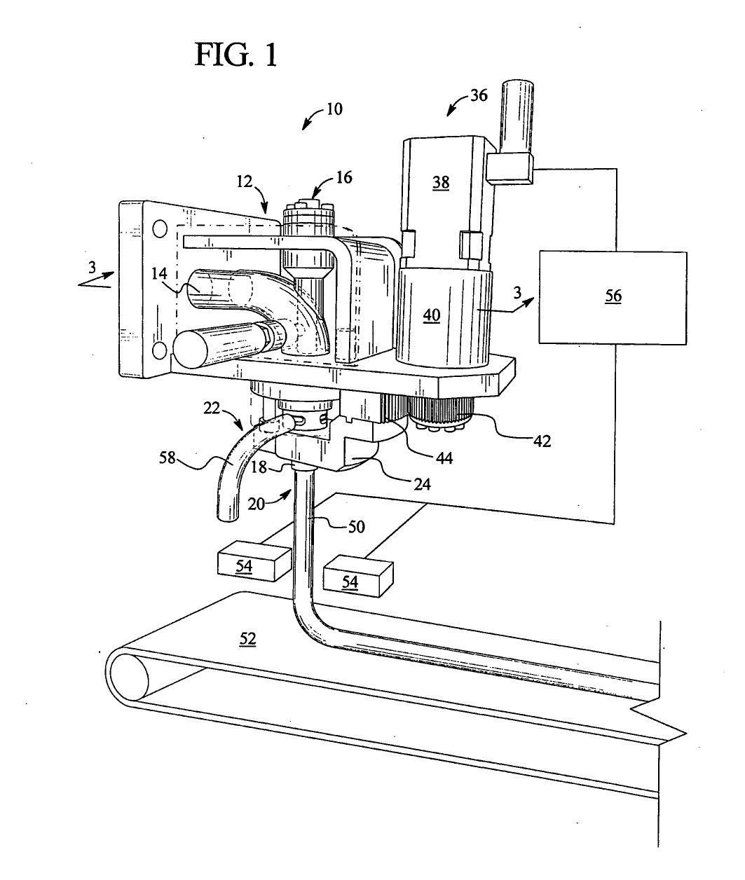

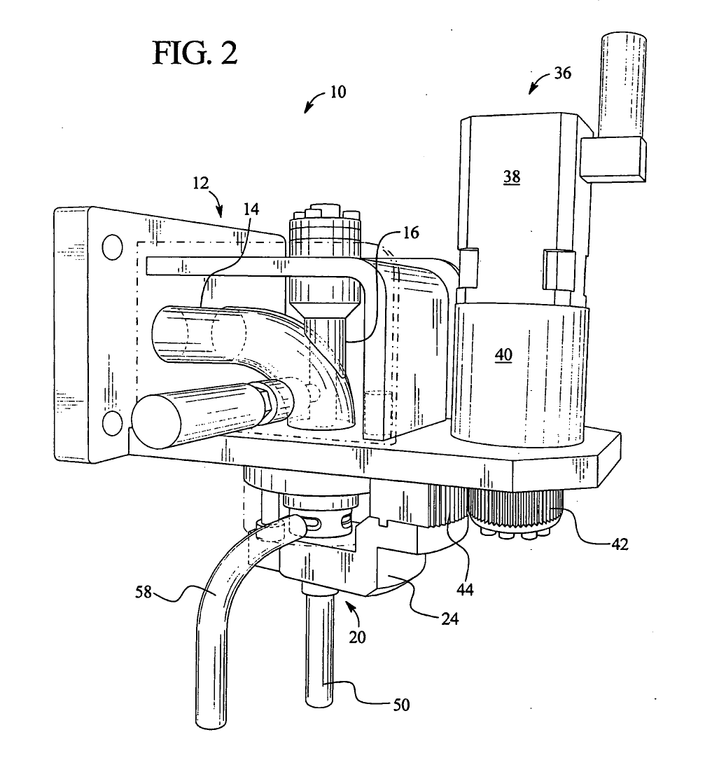

Referring to the Figures generally, where like reference numerals denote like structure and elements, and in particular to FIGS. 1-3, a confectionery depositing apparatus 10 for producing a multiple component confectionery product is shown. Apparatus 10 includes a housing 12, containing an outer passageway 14 and an inner passageway 16. FIGS. 1 and 2 show housing 12 partially broken-away to expose the internal components of apparatus 10. Passageways 14 and 16 are each adapted to receive a respective fluid confectionery material 14a and 16a from respective fluid confectionery sources (not shown). Non-limiting examples of suitable confectionery sources include extruders and hoppers, as are known in the art. Establishment of fluid communication between passageways 14 and 16 and respective sources of confectionery materials 14a and 16a may be accomplished (i.e., piping or tubing) as is commonly known in the art. Housing 12 in FIGS. 1 and 2 is partially broken-away to expose the configuration of the passageways therein. It is understood that housing 12 is enclosed. Confectionery materials 14a and 16a may flow through respective passageways 14 and 16 by way of a flow system such as a screw extruder or by gravity as is commonly known in the art.

In an embodiment, each confectionery source and/or housing 12 may include heating elements (not shown) to maintain the confectionery material in a flowable state. The confectionery materials may be the same or different. Accordingly, sources of confectionery materials 14 and 16 may be adapted to maintain each confectionery material at the same or at different temperatures.

Confectionery materials 14a and 16a may include any confectionery material that flows, is flowable, may be placed into a flowable state, or otherwise provides a plastic confectionery material. Nonlimiting examples of flowable, fluid or plastic confectionery material includes syrups, liquids, gels, pastes, colloids, or solids for making hard candies, boiled candies, soft candies, lollipops, fondants, toffees, jellies, chewing gums, bubble gums, chocolates, gelatins, caramel, taffy, nougats, and powdered or granular candy. The confectionery material may include sugar or may be sugar-free. The confectionery material may further include a pharmaceutical product or a medicament.

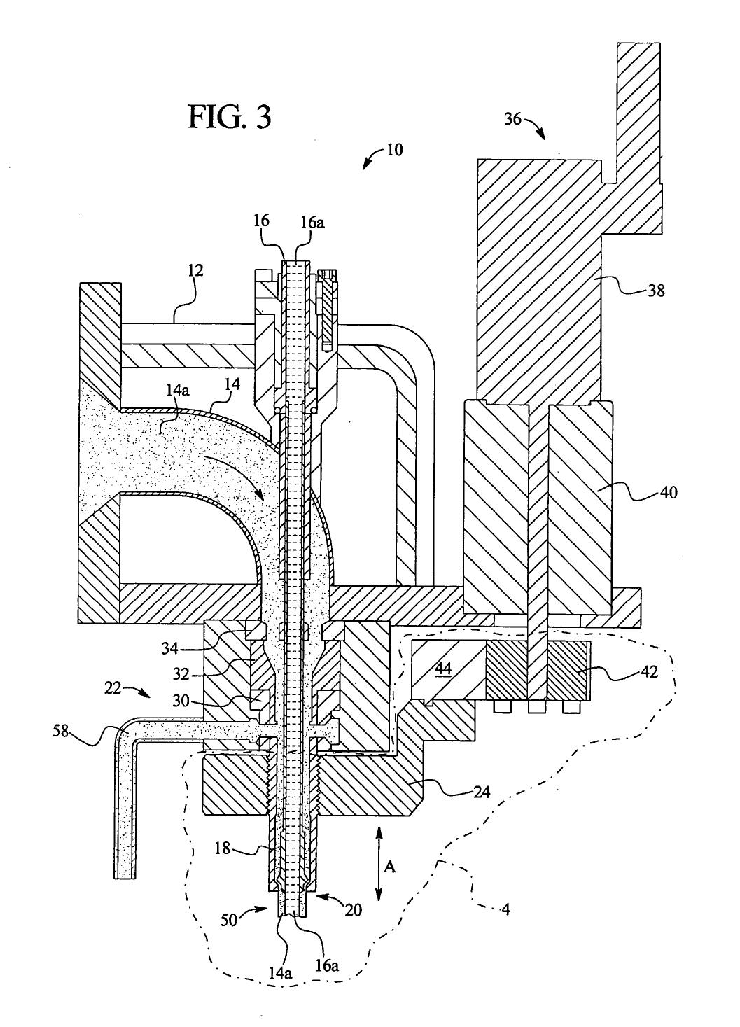

As can be seen in FIGS. 1-3, outer passageway 14 is concentrically disposed about and surrounds inner passageway 16. An outlet member 18 surrounds outer passageway 14 at the downstream portion 22 of apparatus 10. Outlet member 18 and the downstream end of inner passageway 16 form common exit port 20. As is best seen in FIG. 3, the inner surface of outlet member 18 and the outer surface of inner passageway 16 define outer passageway 14 at downstream portion 22 of apparatus 10. In other words, outlet member 18 surrounds inner passageway 16 at downstream portion 22 to maintain or otherwise define outer passageway 14 from downstream portion 22 to exit port 20.

Outlet member 18 is moveable with respect to outer and inner passageways 14 and 16. Outlet member 18 is moveable about the length of inner passageway 16. Consequently, outlet member 18 may be rotated around the outer and inner passageways, outlet member 18 may be moved or slid along the lengths of the outer and inner passageways, or outlet member 18 may be moved in any combination of rotation and/or up and down movement. In an embodiment, the outer surface of outlet member 18 is operatively engaged with the inner surface of actuating arm 24. Rotation of actuating arm 24 consequently rotates outlet member 18 with respect to passageways 14 and 16 to move outlet member 18 in an up-and-down or otherwise vertical manner as indicated by arrow A as shown in FIG. 3. Outlet member 18 thereby moves along the length of passageways 14 and 16.

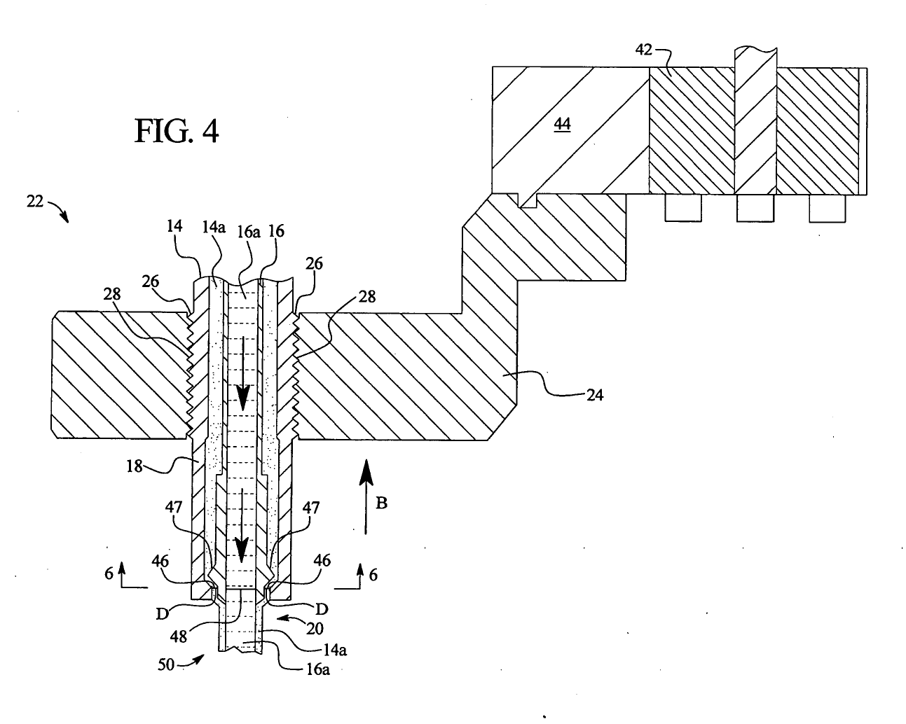

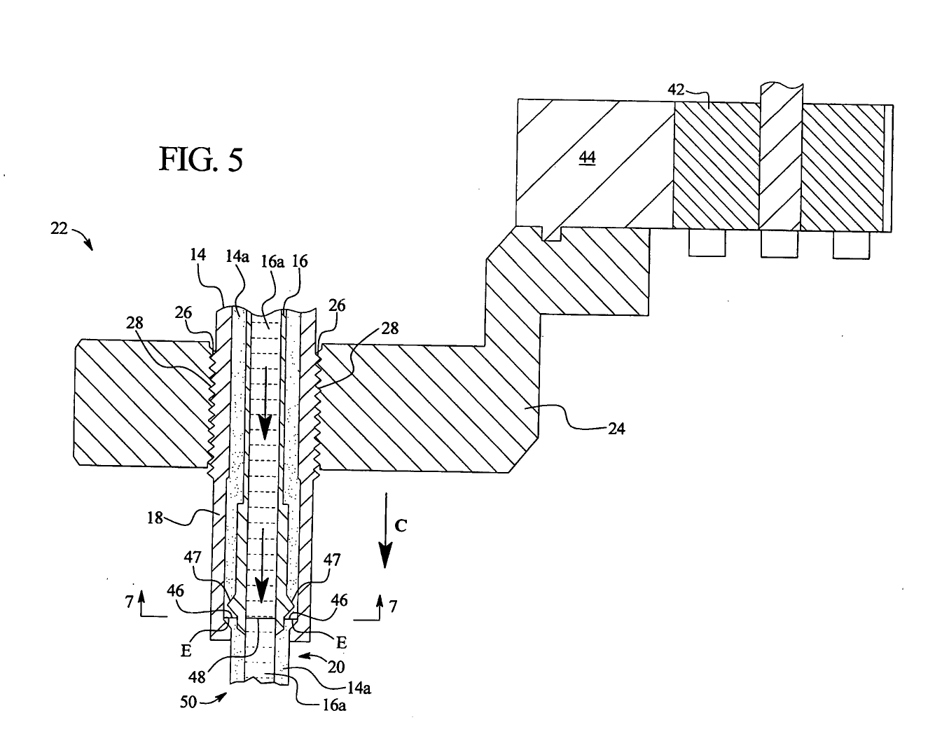

In an embodiment, the outer surface of outlet member 18 may have threads or teeth 26 that matingly engage with corresponding threads or teeth 28 disposed on the inner surface of actuating arm 24 as shown in FIGS. 4 and 5. When actuating arm 24 is rotated, threads 28 engage threads 26 to move, drive or otherwise screw outlet member 18 in an up or down manner as desired. Alternatively, actuating arm 24 may be fixedly engaged to the outer surface of outlet member 18 to rotate the outlet member about the passageways, to vertically move outlet member 18 along the length of passageways 14, 16.

In a further embodiment, apparatus 10 includes a drive mechanism 36 that may be used to rotate actuating arm 24. Drive mechanism 36 includes a servo motor 38 attached to an actuating member 40 which drives a gear 42. Attached to actuating arm 24 is cog 44. The teeth of gear 42 intermesh with the teeth of cog 44 to rotate actuating arm 24 around the passageways in an up-and-down manner.

As shown in FIG. 3, support member 30 holds outlet member 18 within apparatus 10 during movement thereof. Outlet member 18 has a lip 32 that extends along the top surface of support member 30 to secure outlet member 18 within apparatus 10. Support member 30 may be rigid or flexible in order to maintain or otherwise ensure leak-free fluid communication for outer passageway 14, particularly in downstream portion 22. Support member 30 may be a washer or a bushing for example and may be made of metal, a polymeric material, an elastomeric material, or a combination thereof as is commonly known in the art.

Spacing member 34, as shown in FIG. 3, is made of a resilient and flexible material and maintains a leak-free outer surface for outer passageway 14. In an embodiment, spacing member 34 is flexible and compressible to ensure leak-free outer passageway 14, particularly between the outer passageway portion in housing 12 and the outer passageway portion in downstream portion 22. Spacing member 34 ensures outer passageway 14 is leak-free regardless whether outlet member 18 is being moved, rotated, or when outlet member 18 is stationary. Nonlimiting examples of components suitable for use as spacing member 34 include washers or gaskets made of flexible and/or compressible materials such as rubber, polymeric material or elastomeric material as commonly known in the art.

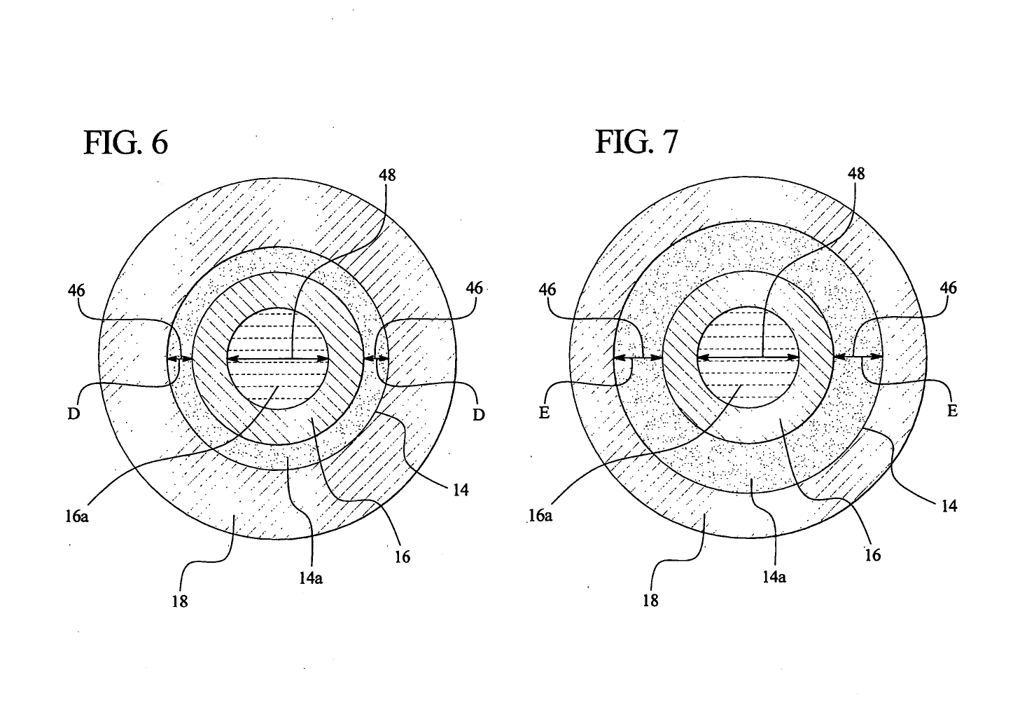

Outer passageway 14 has an outer diameter 46 and inner passageway 16 has an inner diameter 48 as shown in FIGS. 4-7. Not wishing to be bound to any particular theory, outer diameter 46 may be a straight line segment that extends through the common center of concentric passageways 14 and 16, the line segment terminating at the periphery of the inside surface of outlet member 18. Thus, outer diameter 46 may or may not include or be coextensive with inner diameter 48. Regardless, whether diameter 46 includes or overlaps, inner diameter 48, one of ordinary skill in the art will appreciate that the length, distance, or linear extent of outer diameter 46 may vary or change with movement of outlet member 18. Outer diameter 46 may be considered the diameter line segments that are not coextensive with inner diameter 48. In other words, outer diameter 46 may be the diameter line segments that extend from the outer surface of inner passageway 16 to the inner surface of outlet member 18 as shown in FIGS. 6 and 7. Thus, the length of outer diameter 46 varies with the rotation and/or movement of outlet member 18. For example, when outlet member 18 is moved vertically upward along the passageways as shown by arrow B in FIG. 4, the length or the linear extent of outer diameter 46 has a shortened length or distance D as shown in FIGS. 4 and 6. In other words, moving outlet member 18 upward decreases the length of outer diameter 46. When outlet member 18 moves vertically downward with respect to the passageways, outer diameter 46 has an increased length or distance E as shown in FIGS. 5 and 7. Thus, the downward movement of outlet member 18 increases the length or linear extent of diameter 46. By varying the length or distance of outer diameter 46, the amount of outer fluid confectionery 14a that is coextruded with inner confectionery 16a may be adjusted as desired.

In an embodiment, the outer surface of inner passageway 16 may include a baffle 47. Baffle 47 protrudes outwardly into outer passageway 14 restricting the flow of fluid confectionery 14a. The presence of baffle 47 in conjunction with outlet member 18 provides precise control of the flow rate of outer confectionery material 14a. The present apparatus advantageously provides improved control of flow adjustment as movement of outlet member 18 controls the confectionery flow rate at the most downstream point of the passageways, namely common exit port 20.

Outlet member 18 may be moved either manually or automatically to adjust the amount of outer fluid confectionery 14a codispensed or otherwise coextruded with inner fluid confectionery 16a. Upon exit from common exit port 20, outer fluid confectionery 14a surrounds, envelops, or otherwise fully encases fluid confectionery 16a to form a multiple component extrudate 50. Extrusion of fluid confectioneries 14a and 16a may be the result of gravity, alone or in combination with a confectionery feed system, such as an extrusion screw, as is commonly known in the art. A conveyor 52 may be disposed adjacent to exit port 20 to receive extrudate 50. Although FIG. 1 shows conveyor 52 located below apparatus 10 to receive vertically dispensed extrudate 50, apparatus 10 may be located next to conveyor 52 to dispense extrudate 50 onto conveyor 52 in a horizontal manner as is commonly known in the art.

In an embodiment, apparatus 10 includes a sensor device 54 in operative communication with apparatus 10 by way of a controller 56. Sensor device 54 may be placed proximate to common exit port 20 and configured to detect a property of extrudate 50. Alternatively, sensor device 54 may be positioned at common exit port 20, or may be a component of common exit port 20. Nonlimiting examples of suitable devices that may be used as sensor device 54 include one or more pairs of light emitter/receiver, a flowmeter, a weighing device, and combinations thereof. The light emitter/receiver may be used to detect the diameter of extrudate 50. One or more emitter/receivers may be used in one or more planes for detection of the extrudate diameter as desired. In an embodiment, the light emitter/receiver may be a laser light emitter/receiver pair as is commonly known in the art. In a further embodiment, the light emitter/receiver may detect variance in the extrudate diameter as fine as about ±10 microns, or about ±2 microns, or about ±1 micron. Thus, sensor device 54 may be used to detect fine variations of a given property of extrudate 50.

Sensor device 54 may include a flow meter that detects the flow of outer fluid confectionery 14a and/or inner fluid confectionery 16a The flow meter may be placed directly at exit port 20 or adjacent to the exit port. The flow meter may provide precise flow rate detection on the order of about ±0.01 mm/second. In addition, sensor device 54 may also include a weighing device, such as a scale for example, to weigh a segment of extrudate 50. The weighing device may be a stand-alone device or may operate in conjunction with conveyor 52. The weighing device may be configured to detect very small variations in weight of a segment of extrudate 50. For example, the weighing device may detect weight variance as small as about ±0.01 mg. Thus, sensor device 54 may be configured to detect any desired property of the extrudate including nonlimiting examples such as the extrudate diameter, the flow rate of the extrudate, the flow rate of one or both fluid confectioneries, the weight of a segment of the extrudate, and any combination thereof.

In an embodiment, sensor device 54 detects a property of extrudate 50 and sends a detection signal to a controller 56 based on the detected property. Controller 56 is in operative communication with servo motor 38. This connection places sensor device 54 in operative communication with outlet member 18, (i.e., sensor-controller-drive mechanism-outlet member). Controller 56 may be any controlling device commonly known in the art such as a programmable logic controller or similar device, for example. Operative communication between controller 56, sensor device 54, and servo motor 38 may be by way of such nonlimiting examples as electrical connection, mechanical connection, Internet connection, Bluetooth connection, RF frequency connection, optical connection, IR connection and the like. The detection signal sent by sensor device 54 is received and processed by controller 56. Based on the detection signal, controller 56 directs servo motor 38 to drive gear 42 in a clockwise direction, a counter-clockwise direction, or directs servo motor to remain stationary. Controller 56 is configured to move outlet member 18 in response to the detected signal.

The logic of controller 56 may be programmed or otherwise configured to direct drive mechanism 36 to move outlet member 18 in order to increase or decrease the length of outer diameter 46 based upon a comparison between the value of the detected property and a predetermined threshold value. For example, a light emitter/receiver may detect the diameter of the extrudate 50 and send this detected extrudate diameter value in the detection signal to controller 56. Controller 56 may be configured to compare this detected extrudate diameter value to a threshold extrudate diameter value. When the detected extrudate diameter value is below the threshold extrudate diameter value, controller 56 then directs drive mechanism 36 to move outlet member 18 to increase the length of outlet diameter 46, thereby increasing the amount of fluid confectionary 14a discharged from outer passageway 14.

Similarly, when the detected extrudate diameter value is greater than the threshold extrudate diameter value, or optionally greater than or equal to the threshold value, controller 56 may be configured to direct drive mechanism 36 to move outlet member 18 upward thereby reducing the flow rate or otherwise reducing the amount of outer fluid confectionery 14a dispensed from outer passageway 14. Controller 56 may be configured to compare detected flow rate values and detected weight values to respective flow rate and weight threshold values in a similar manner.

In an embodiment, the time duration between property detection of extrudate 50 by sensor device 54, transmission of the detection signal to controller 56, processing of the detection signal by controller 56 and movement of outlet member 18 is from about 0.01 seconds to about 1.0 seconds, or about 0.05 seconds to about 0.5 seconds, or from about 0.05 seconds to about 0.1 seconds. In a further embodiment, controller 56 may be configured to determine the amount of movement required by outlet member 18 to maintain extrudate 50 within a predetermined tolerance range. Correspondingly, gear 42 and cog 44 may each have fine intermeshing teeth enabling very fine adjustment of the length of outer diameter 46. In an embodiment, outlet member 18 may be moved to affect a change in diameter 46 length of from about 0.001 mm to about 2.0 mm, or about 0.01 mm to about 0.2 mm. Apparatus 10 advantageously provides immediate detection of an extrudate property and immediate adjustment of confectionery flow in response to the property detection. Apparatus 10 further advantageously extrudes a multiple component confectionery having a uniform diameter along substantially the entire length of the extrudate within exceptionally tight and precise tolerance. For example, the uniform diameter of extrudate 50 may have a tolerance rage of about ±100 microns, or about ±10 microns, or about ±2 microns, or about ±1 microns.

In a further embodiment, apparatus 10 may include an overflow channel 58 in fluid communication with outer passageway 14 as shown in FIGS. 1-3. Overflow channel 58 provides a flow route for outer fluid confectionery 14a when the length of outer diameter 46 slows the flow rate of outer fluid confectionery 14a in outer passageway 14. Overflow channel 58 also accommodates any confectionery flow irregularities that occur in the upstream portion of housing 12. Provision of overflow channel 58 advantageously promotes a more regulated and even flow of outer fluid confectionery 14a regardless of the degree of movement, either minimal or extreme, of outlet member 18 with respect to the passageways. In an embodiment, overflow channel 58 may be configured to be placed in fluid communication with the source of outer fluid confectionery 14a This advantageously eliminates waste by recycling unused confectionery back to the source. Such a configuration also maintains the fluid confectionery in a fresh condition.

Apparatus 10 may be used to coextrude or otherwise form a multiple component confectionery article that includes an inner confectionery material and an outer confectionery material that surrounds the inner confectionery material. Apparatus 10 may advantageously be used to ensure that the confectionery article has a uniform diameter along substantially the entire length of the confectionery article. In an embodiment, the inner and outer confectionery materials may be selected from syrup, paste, colloid, boiled candy, hard candy, soft candy, toffee, jelly, chewing gum, bubble gum, chocolate, gelatin, caramel, taffy, nougat, powder candy, or granular candy. In a further embodiment, the outer confectionery material of the article is chewing gum or bubble gum.

In yet a further embodiment, the confectionery article has an outer confectionery material that is chewing gum or bubble gum, and an inner confectionery material of a granular candy, a syrup, or a chewing gum. The confectionery article may be a finished confectionery product. Alternatively, the confectionery article may be a precursor to a finished confectionery product. For example, the confectionery article may be a rope or strand that may be subjected to further processing steps to form shaped confectionery products such as filled gum balls or filled candies, for example. As a confectionery product precursor, the present confectionery article provides a confectionery strand having a uniform diameter within extremely tight or otherwise narrow tolerances. For example, the confectionery article may be a coextruded rope having a uniform diameter along the entire length of the rope, the diameter varying only within about ±100 microns, or about ±10 microns, or about ±1 micron. This is advantageous as the uniform diameter ensures that the outer confectionery material fully encases or otherwise fully surrounds the inner confectionery material after processing steps that shape the confectionery rope into a finished confectionery product. Provision by apparatus 10 of a coextruded confectionery rope with a uniform diameter thereby significantly reduces the amount of product reject-namely product with inner confectionery material exposed to the ambient environment.

It should be understood that various changes and modifications to the present embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An apparatus for producing a multiple component confectionery product comprising:
an outer passageway concentrically disposed about an inner passageway, the passageways having a common exit port, the outer passageway having an outer diameter; and
an outlet member surrounding the outer passageway, the outlet member moveable about the outer passageway to vary the outer diameter.

2. The apparatus of claim 1 further comprising a first fluid confectionery in the outer passageway and a second fluid confectionery in inner passageway, the outer fluid confectionery surrounding the inner fluid confectionery and forming a multiple component extrudate upon exit from the exit port.

3. The apparatus of claim 2 wherein the extrudate has a substantially uniform diameter.

4. The apparatus of claim 2 further comprising a sensor device proximate to the exit port and in operative communication with the outlet member, the sensor device detecting a property of the extrudate.

5. The apparatus of claim 4 wherein the sensor device sends a detection signal to a controller in operative communication with the sensor device and the outlet member, the controller configured to move the outlet member in response to the detection signal.

6. The apparatus of claim 4 wherein the sensor device is selected from the group consisting of a light emitter/receiver, a weighing device, a flowmeter and combinations thereof.

7. The apparatus of claim 4 wherein the property is selected from the group consisting of a diameter of the extrudate, a weight of the extrudate, a flow rate of the extrudate, a flow rate of an outer fluid confectionery, a flow rate of an inner fluid confectionery, and combinations thereof.

8. The apparatus of claim 5 wherein the detection signal includes a detection value and the outlet member moves to increase the length of the outer diameter when the detection value is below a predetermined value.

9. The apparatus of claim 5 wherein the detection signal includes a detection value and the outer member moves to decrease the length of the outlet diameter when the detection signal is greater than a predetermined value.

10. The apparatus of claim 5 further comprising a drive mechanism in operative communication with the controller and outlet member, the drive mechanism configured to move the outlet member.

11. A method for producing a multiple component confectionery article comprising:
coextruding an outer fluid confectionery and an inner fluid confectionery from respective outer and inner concentric passageways having a common exit port, the outer passageway having an outlet diameter, and an outlet member surrounding the outer passageway, and
moving the outlet member about the outer passageway to vary the outlet diameter.

12. The method of claim 11 further comprising
surrounding the inner fluid confectionery with the outer fluid confectionery to form a multiple component extrudate;
detecting a property of the extrudate; and
adjusting the moving responsive to the detected property.

13. The method of claim 12 wherein the extrudate has a length, the method further comprising forming an extrudate having a substantially uniform diameter along substantially the entire extrudate length.

14. The method of claim 12 wherein the time duration between the detecting and the adjusting is from about 0.01 seconds to about 1.0 second.

15. The method of claim 12 further comprising moving the outlet member to increase the outer diameter when the property is below a predetermined value.

16. The method of claim 12 further comprising moving the outlet member to decrease the outer diameter when the property is greater than a predetermined value.

17. The method of claim 12 wherein the detecting is performed by a sensor device selected from the group consisting of a light emitter/receiver, a weighing device, a flowmeter and combinations thereof.

18. A multiple component confectionery article having a length comprising:
an inner confectionery material; and
an outer confectionery material surrounding the inner confectionery material, the confectionery article having a substantially uniform diameter along the entire length.

19. The confectionery article of claim 18 wherein the inner and outer confectionery materials are selected from the group comprising of syrup, paste, colloid, boiled candy, hard candy, soft candy, toffee, jelly, chewing gum, bubble gum, chocolate, gelatin, caramel, taffy, nougat, and granular candy.

20. The confectionery article of claim 19 wherein the outer confectionery material is selected from the group consisting of chewing gum and bubble gum.
